(19) United States
(12) Patent Application Publication
(10) Pub. No.: US 2023/0214522 A1
(43) Pub. Date: Jul. 6, 2023

(54) AUTOMATIC DETECTION OF PERSONAL IDENTIFIABLE INFORMATION

(71) Applicant: Intuit Inc., Mountain View, CA (US)

(72) Inventors: Daphna LITVIN, Tal Shahar (IL); Elad Shmidov, Kfar Saba (IL); Margarita Vald, Tel-Aviv (IL)

(73) Assignee: Intuit Inc., Mountain View, CA (US)

(21) Appl. No.: 17/568,845

(22) Filed: Jan. 5, 2022

(51) Int. Cl. G06F 21/62; G06F 16/903

(52) U.S. Cl. CPC G06F 21/6245; G06F 16/90335

(57) ABSTRACT

Described herein are example implementations for the automatic detection and handling of personal identifiable information (PII) in electronic records. In some aspects, a system receives one or more computer readable logs of information for one or more computer services, with each log including a string of characters. The system performs one or more string search algorithm based operations on the entirety of the one or more strings of the one or more computer readable logs to identify a range of the one or more strings to be searched for PII that is less than the entirety of the one or more strings. The system also performs one or more regular expression algorithm based operations on the range of the one or more strings to identify one or more instances of PII. The system generates and outputs an indication of the one or more instances of the PII that are identified.

### TECHNICAL FIELD

This disclosure relates generally to automatic detection of personal identifiable information, including real-time detection and handling of personal identifiable information in computer readable logs.

### DESCRIPTION OF RELATED ART

Various operations are performed online daily, such as accessing the news or other subscription based services, checking social media accounts, performing online banking, scheduling appointments through an online portal, and so on. The online interactions by a person may cause a log of the interaction to be generated for a provider of the service accessed by the person. For example, if the person accesses a social media account, the social media provider may log when the person logged into his or her account, where the person logged into his or her account, or other potentially sensitive information. In another example, if the person signs up for a new streaming content subscription, the streaming content provider may log the person’s billing address, credit card information, birthdate, or other potentially sensitive information. There is a need to protect potentially sensitive information from being discoverable by others.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a computer-implemented method for automatic detection of personal identifiable information (PII). The method includes receiving one or more computer readable logs of information for one or more computer services. Each log includes a string of characters. The method also includes performing one or more string search algorithm based operations on the entirety of the one or more strings of the one or more computer readable logs to identify a range of the one or more strings to be searched for PII that is less than the entirety of the one or more strings. The method further includes performing one or more regular expression algorithm based operations on the range of the one or more strings to identify one or more instances of PII. The method also includes generating an indication of the one or more instances of the PII that are identified and outputting the indication.

Another innovative aspect of the subject matter described in this disclosure can be implemented in a system for compliance document processing. An example system includes one or more processors and a memory storing instructions that, when executed by the one or more processors, cause the system to perform operations. The operations include receiving one or more computer readable logs of information for one or more computer services. Each log includes a string of characters. The operations also include performing one or more string search algorithm based operations on the entirety of the one or more strings of the one or more computer readable logs to identify a range of the one or more strings to be searched for PII that is less than the entirety of the one or more strings. The operations further include performing one or more regular expression algorithm based operations on the range of the one or more strings to identify one or more instances of PII. The operations also include generating an indication of the one or more instances of the PII that are identified and outputting the indication.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example network of a computing system and user system for the handling of computer readable logs including personal identifiable information (PII), according to some implementations.

FIG. 2 shows an example computing system to automatically detect and handle PII, according to some implementations.

FIG. 3A shows an example dictionary, according to some implementations.

FIG. 3B shows an example plurality of dictionaries, according to some implementations.

FIG. 3C shows another example plurality of dictionaries, according to some implementations.

FIG. 4 shows an example process flow to detect PII, according to some implementations.

FIG. 5 shows an illustrative flow chart depicting an example process for detecting PII in one or more computer readable logs, according to some implementations.

Like numbers reference like elements throughout the drawings and specification.

### DETAILED DESCRIPTION

Implementations of the subject matter described in this disclosure may be used for the automatic detection and handling of personal identifiable information (PII) in computer readable logs. In particular, systems and methods are described to reduce the range of characters in computer readable logs for which a regular expression search is performed to detect PII. For example, a string search may be used to limit which subsets of logs or which portions of a log are to be searched using a regular expression search to identify PII.

As used herein, PII may refer to any sensitive information that may be used to identify a person or otherwise that a person may desire to keep hidden from others. In some instances, PII may refer to data that must be protected because of regulatory requirements. For example, the European Union has implemented the General Data Protection Regulation (GDPR) to require certain personal information be protected. In another example, California has implemented the California Consumer Privacy Act (CCPA) to require certain personal information be protected. In a further example, the United States has implemented the Health Insurance Portability and Accountability Act of 1996 (HIPAA) to require the protection of sensitive patient health information. As such, protection of some PII (such as genetic data, biometric data, or religious or philosophical beliefs) from others may be required by law. However, other PII also exists that a person may desire to be protected. Example PII include, e.g.: a person’s full name; a birthdate or portions of a birthdate; a birth location; a social security number (SSN), a tax identification number (TIN), or other government issued identification number; a phone number; an email address; a mailing address; a credit card number; a card verification value (CVV); a card or account personal identification number (PIN); a private key; a password; or other credentials.

When a person or other entity interacts with a computer program or service, a computer readable log of the interaction or otherwise regarding an individual may be created. For example, a person may access an on-demand video streaming service. If the user subscribes to the video streaming service, the user may provide a credit card number, a billing address, a username and password to be used to access the service, or other PII. PII may be included in one or more computer readable logs as record of the person signing up for the service or the person accessing the service. In another example, a company may use a payroll service to automatically deduct and pay income taxes, social security taxes, retirement account fundings, health insurance premiums, and so on before mailing a paper paycheck or direct depositing a paycheck for one or more employees. Computer readable logs corresponding to the company’s interaction with the payroll service may include an SSN, a mailing address, or other PII of the employee. In another example, a person or couple may apply for a home mortgage online through a mortgage servicer, with the mortgage application including an SSN, a mailing address or other contact information, a birthdate, and other PII, which may be included in one or more computer readable logs corresponding to the mortgage application process. While some example interactions are depicted above, various interactions with a variety of services exist for which computer readable logs including PII are generated. As used herein, a computer service may refer to any type of service accessed locally (such as via a local computing system) or remotely (such as via the internet) for which computer readable logs may be generated. Example computer services include tax preparation services, on demand audio or video streaming services, banking or financial management services, payroll services, online news or magazine subscription services, social media services, and so on.

Computer readable logs are stored in a repository and may be used for ongoing operations of the product or service provider. For example, a company providing a video streaming service may use the computer readable logs to determine the number of active subscriptions, whether contact information is to be updated, or other information regarding the operation of the company. As such, the computer readable logs may be read by company employees or others. As noted above, at least some PII is to be protected from others. For example, some PII in a computer readable log may be obfuscated from employees and others before such person is able to access the computer readable log. To protect the privacy of customers and other individuals, computer readable logs may be scrubbed to obfuscate PII before being accessed by others. For example, a security team under confidentiality may manually review computer readable logs for PII. With computer readable logs having PII (and the PII itself) identified, the security team may remove or replace any identified PII in the computer readable logs. As used herein, scrubbing refers to the process of obfuscating or otherwise making specific information unavailable to others. For example, scrubbing a computer readable log may refer to the computer readable log being quarantined from access by others, the PII being deleted from the computer readable log, the PII being replaced in the computer readable log with a different identifier that is not PII, or the PII being replaced with a generic character or character string indicating PII was hidden.

A large service provider may have millions or billions of computer readable logs needing review. For example, millions of computer readable logs may be generated per second. For example, for an on demand video streaming service, a computer readable log may be generated for a plurality of interactions for each login to a user account. If 100,000 people log in in one day, at least 100,000 computer readable logs are to be reviewed for that day. Manual review of all of the computer readable logs (much less reviewing in real time computer readable logs when generated) would be impossible as an unrealistically large security team would be required for reviewing the logs. As such, there is a need for some form of computer assisted review of computer readable logs to detect PII to enable a company to review and scrub all computer readable logs as desired.

A computer readable log includes a string of characters that may be searched by a computing system for PII. Many systems may use a regular expression algorithm based search (also referred to as a regular expression search or a regex search, which may include one or more regular expression algorithm based operations) to search for formatted sequences of characters (referred to as regular expressions or expressions) that may correspond to PII. A regex search includes one or more operations to search for one or more defined sequences of characters. For example, a character sequence in the format of “MM:DD:YY” may be a birthdate, and such a sequence may be searched for in a computer readable log. The expressions to be searched for are predefined. For example, a system includes a dictionary of different expressions to be searched for, and the system uses the dictionary to configure and search for each of the defined expressions in each of the computer readable logs.

One benefit of regular expression algorithm based searches is that a pattern may be modified are broad for searching for an expression, such as through the use of a metacharacter, wildcard or other operator to modify or expand a pattern to be searched for. Since an expression may be in different formats or use different types of characters, regex searches have sufficient flexibility to find expressions in different formats. A problem with regex searches is that such searches may require a significant amount of processing resources and time. In addition, as the number are variability of expressions to be searched for increases, the amount of processing resources and time required to perform a regex search increases. As such, exclusive use of a regex search to search all computer readable logs, much less to search generated computer readable logs in real-time, may require too many processing resources and too much time to be feasible.

As an alternative to the use of regex searches, some systems may use a string search algorithm based search to search for predefined sequences of specific characters. In using a string search algorithm based search (including one or more string search algorithm based operations), a system searches for only defined character strings as exactly defined. For example, the system may include a dictionary of exactly defined strings to be searched. Since only the exact strings are searched, searching through a plurality of computer readable logs using a string search algorithm may be faster than the use of a regex search. However, a problem with exclusive use of a string search algorithm to identify PII is that some PII may be missed if each exact format of PII is not defined. As noted, PII may be in different formats. For example, a birthdate may be formatted as “MM:DD:YY”, “MM/DD/YY”, “DD:MM:YY”, “YYYY/DD/MM”, have the month spelled out or abbreviated, and so on. In addition to the large differences in formats, PII format may also change over time. In addition, without the use of a metacharacter for, e.g., a birthdate, each specific sequence of each specific group of numbers to identify each possible birthdate would need to be searched to find all birthdates. As such, if the dictionary including the character strings to be searched does not include every variation in the PII, some PII may be missed in the computer readable logs. Another problem is that every variation of the PII to be searched may cause the dictionary to be so large that exclusive use of a string search may also require too many processing resources and too much time to be feasible to search all computer readable logs, much less to search generated computer readable logs in real-time, for PII.

Various implementations of the subject matter disclosed herein provide one or more technical solutions to the technical problem of automatically detecting and handling PII in one or more computer readable logs. In some implementations, a computing system is configured to receive one or more computer readable logs of information for one or more computer services. Each log includes a string of characters. The computing system is also configured to perform one or more string search algorithm based operations on the entirety of the one or more strings of the one or more computer readable logs to identify a range of the one or more strings to be searched for PII that is less than the entirety of the one or more strings. The computing system is also configured to perform one or more regular expression algorithm based operations on the range of the one or more strings to identify one or more instances of PII. The computing system is also configured to generate an indication of the one or more instances of the PII that are identified and output the indication. The computing system may also be configured to scrub one or more computer readable logs to protect any detected PII.

Various aspects of the present disclosure provide a unique computing solution to a unique computing problem that did not exist prior to the creation of computer-based services. In addition, reviewing millions of electronic records in a short amount of time (such as every second or minute) cannot be performed in the human mind, much less using pen and paper. As such, implementations of the subject matter disclosed herein are not an abstract idea such as organizing human activity or a mental process that can be performed in the human mind.

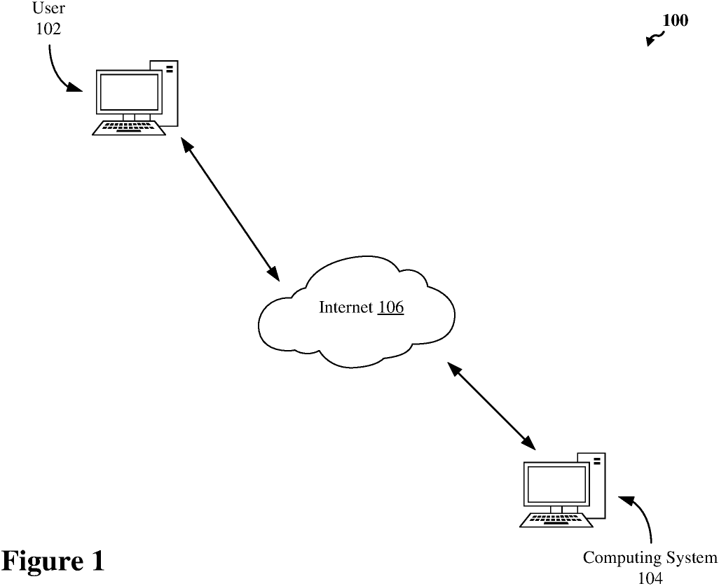

FIG. 1 shows an example network 100 of a computing system 104 and user system 102 for the handling of computer readable logs including PII, according to some implementations. In some implementations, the computing system 104 may be a system to provide a service to a user. In some other implementations, the computing system 104 may perform the identification of PII in computer readable logs for a service, with some other system providing the service to the user. For example, the service may be Intuit® QuickBooks (QBO), which is an online accounting service provided to various individuals and businesses. While QBO is provided as an example, any suitable service may be used in performing aspects of the present disclosure. While one service is depicted as being provided, in some implementations, a plurality of services may be provided, with computer readable logs being generated for each service.

If the computing system 104 provides the service to users, the software may be hosted and executed at the computing system 104, and a user may access his or her account via a webpage, local application, or other suitable graphical user interface (GUI) at the user system 102, with the user system 102 communicating with the computing system 104 over the internet 106. While the computing system 104 is shown as one device, the computing system 104 may include a plurality of devices, such as a plurality of servers configured in a distributed manner (such as in a cloud configuration). In addition, while one user device 102 is shown, a plurality of user devices may communicate with the computing system 104.

In some implementations, the computing system 104 may perform the operations of identifying and handling PII as described herein. For example, the computing system 104 may generate computer readable logs that are placed into a suitable memory, and the computing system 104 may process the computer readable logs in the memory to detect PII. In some other implementations, a separate computing system from computing system 104 may perform the operations of identifying and handling PII as described herein. For example, the computing system 104 may generate the computer readable logs when providing the service, and the computing system 104 may place the computer readable logs into any suitable repository (such as an internal memory, an external database, and so on). The computing system to identify PII may access the repository and receive the computer readable logs for processing.

As noted above, a computer readable log (log) includes a string of characters. In some implementations, a log may include semi-structured data. For example, for QBO, a log may be a JavaScript Object Notation (JSON) file with objects separated from one another using a defined character (such as a comma). An example log is depicted in example (1) below:

{“workState”:“NV”,“hireDate”:“2015-05-05T00:00:00.000Z”,“birthDate”:“ 1990-09- (1)
20T00:00:00.000Z” }

As depicted in example (1), the computer readable log indicates an individual’s birthdate, starting date, and US state of employment for a business. Another example log is depicted in example (2) below:

{“Id”:“1234”,“Line1”:“Address:567”,“Line2”:“Carowinds Street”,“Line3”:“Phone: (2)
438-490-3638”,“Line4”:“Email:example@email.com”,“Line5”:“DOB:1980/01/01”}

As depicted in example (2), the computer readable log includes an identification (ID) number to identify the specific log, a mailing address, a phone number, an email, and a date of birth. While the examples are depicted as being one line of a string of characters devoid of spacing, spaces, new lines, or other special characters may exist in the string of characters of a log. In some implementations, a log is processed as if such special characters do not exist in the log or such characters are treated the same as other types of characters (such as alphanumeric characters).

As shown in the examples, each expression in a log is associated with context located near the expression in the string of characters. For example, in example (2) above, the birthdate “1980/01/01” is preceded by the context “DOB”. In another example, in example (1) above, “NV” is preceded by the context “workState”. As described herein, the context associated with each object may be referred to as a key. While keys are depicted as preceding its associated expression in the examples, the key may be in any location in close proximity to the expression. For example, the key may succeed the expression. In addition, multiple expressions may be included and associated with the same key. For example, if a key is for previously used passwords for a user account, multiple expressions of previous passwords may be included in the log in close proximity to the key.

Certain expressions may be PII. As described herein, a computing system may leverage the proximity of keys to expressions in computer readable logs to automatically identify PII in computer readable logs. Through operations described herein to leverage the proximity of keys and expressions to identify PII, the amount of time and processing resources required to identify PII is significantly reduced as compared to exclusive use of a regex search (so much so that near real-time identification of PII may be available) while remaining highly accurate in identifying all PII in computer readable logs.

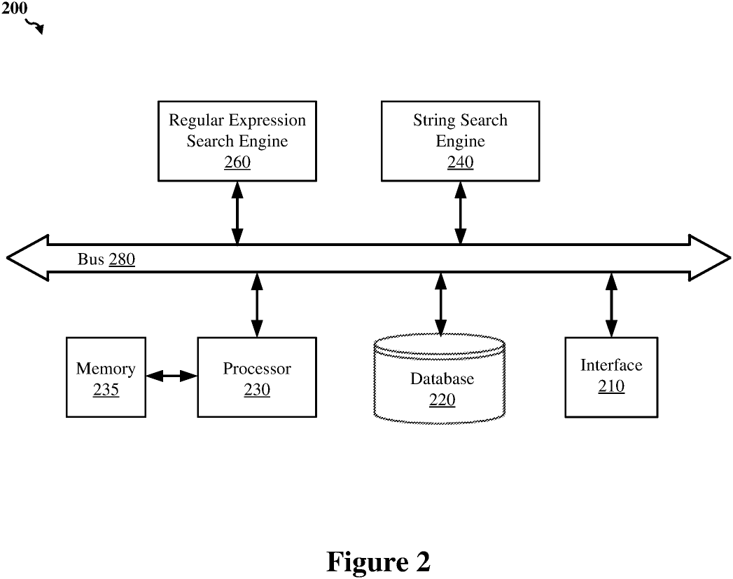

FIG. 2 shows an example system 200 to automatically detect and handle PII, according to some implementations. The system 200 may be an example implementation of the computing system 104 in FIG. 1 or of a computing system to process computer readable logs generated by the computing system 104. The system 200 includes an interface 210, a database 220, a processor 230, a memory 235 coupled to the processor 230, a string search engine 240, and a regular expression (regex) search engine 260. In some implementations, the various components of the system 200 may be interconnected by at least a data bus 280, as depicted in the example of FIG. 2. In other implementations, the various components of the system 200 may be interconnected using other suitable signal routing resources. While not depicted in FIG. 2, in some implementations, the system 200 may also include a scrubbing engine or other suitable components for the handling of the computer readable logs including PII.

The interface 210 may be one or more input/output (I/O) interfaces to obtain computer readable logs or other information to be used by the system 200. The interface 210 may also provide an indication of identified PII, scrubbed computer readable logs, or other information to be output by the system 200. If the system 200 is to provide a service to one or more users (such as hosting and executing QBO or other software to be accessed remotely by users), the interface 210 may receive user interactions and other requests from user systems and provide information to user system when providing the service to the users. In providing the service, the system 200 may generate one or more computer readable logs. If a different system is to provide a service to one or more users and generate the computer readable logs, the interface 210 may receive the computer readable logs generated by the other system (such as by accessing a repository that stores the computer readable logs). An example interface may include a wired interface or wireless interface to the internet or other means to communicably couple with other devices. For example, the interface 210 may include an interface with an ethernet cable or a wireless interface to a modem, which is used to communicate with an internet service provider (ISP) directing traffic to and from one or more client devices (such as a user’s personal computer) or a computing system providing the service. If the interface 210 is configured to provide scrubbed computer readable logs with obfuscated PII, the computer readable logs may be transmitted via a wired or wireless interface to the repository to store the computer readable logs or another suitable device.

As noted above, the interface 210 may be configured to provide an indication of one or more instances of PII identified in one or more computer readable logs. For example, a reviewer to ensure PII is scrubbed from one or more computer readable logs may be local to the computing system 200. In this manner, the interface 210 may include a display, a speaker, a mouse, a keyboard, or other suitable input or output elements that allow interfacing with the reviewer so that the interface 210 may provide an indication of the one or more instances of PII. In some implementations, reviewers may be remote. As such, the system 200 may use the interface 210 to provide the indication to one or more remote reviewers.

The database 220 may store one or more computer readable logs that may be obtained by the interface 210 (with the computer readable logs generated by a different system providing the service) or generated by the system 200 when providing the service. In some implementations, the one or more computer readable logs include one or more JSON objects or files (such as in the format of examples (1) and (2) above). To note, while a JSON file is described herein as including one log, a JSON file may include a plurality of logs. For example, the file may be updated while the service is being provided to include additional logs. As such, the present disclosure is not limited to a specific format of computer readable logs. The database 220 may also store one or more indications of identified PII, computer executable instructions to be executed by the system 200 to perform one or more operations described herein, and one or more scrubbed logs. In some implementations, the database 220 may include a relational database capable of presenting information as data sets in tabular form and capable of manipulating the data sets using relational operators. The database 220 may use Structured Query Language (SQL) for querying and maintaining the database 220. While the examples herein depict operations to be performed by the system 200 for processing one computer readable log for clarity, the system 200 may be configured to process a plurality of computer readable logs for any number of users. As such, the database 220 may be configured to maintain information (such as an identification of PII or scrubbed computer readable logs) for a plurality of computer readable logs.

The processor 230 may include one or more suitable processors capable of executing scripts or instructions of one or more software programs stored in system 200 (such as within the memory 235). For example, the processor 230 may be capable of executing one or more applications, the string search engine 240, or the regex search engine 260. If the system 200 provides the service, the processor 230 may also be capable of executing software associated with the service. The processor 230 may also be capable of executing instructions regarding generating computer readable logs or scrubbing computer readable logs of identified PII. The processor 230 may include a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the processor 230 may include a combination of computing devices (such as a combination of a DSP and a microprocessor, a plurality of microprocessors, one or more microprocessors in conjunction with a DSP core, or any other such configuration).

The memory 235, which may be any suitable persistent memory (such as nonvolatile memory or non-transitory memory) may store any number of software programs, executable instructions, machine code, algorithms, and the like that can be executed by the processor 230 to perform one or more corresponding operations or functions. For example, the memory 235 may store the one or more applications, the string search engine 240, or the regex search engine 260 that may be executed by the processor 230. If the system 200 also is to provide the service, the memory 235 may store one or more programs that may be executed by the processor 230 to provide the service. The memory 235 may also store the computer readable logs before or after processing by the engines 240 and 260, identifications of the PII, scrubbed computer readable logs, or any other data for operation of the system 200. In some implementations, hardwired circuitry may be used in place of, or in combination with, software instructions to implement aspects of the disclosure. As such, implementations of the subject matter disclosed herein are not limited to any specific combination of hardware circuitry and/or software.

In some implementations, the memory 235, the database 220, or another suitable memory of the system 200 may store one or more dictionaries to be used in identifying PII. The one or more dictionaries may indicate the character sequences to be searched for in attempting to identify different types of PII. In some implementations, a dictionary includes one or more keys that may be searched for in a computer readable log. The dictionary may also include one or more expressions associated with each key, and the expressions may also be searched for in a computer readable log. A dictionary may be a JSON object or file or some other form of computer readable object to identify the keys and expressions to be searched for in the computer readable logs.

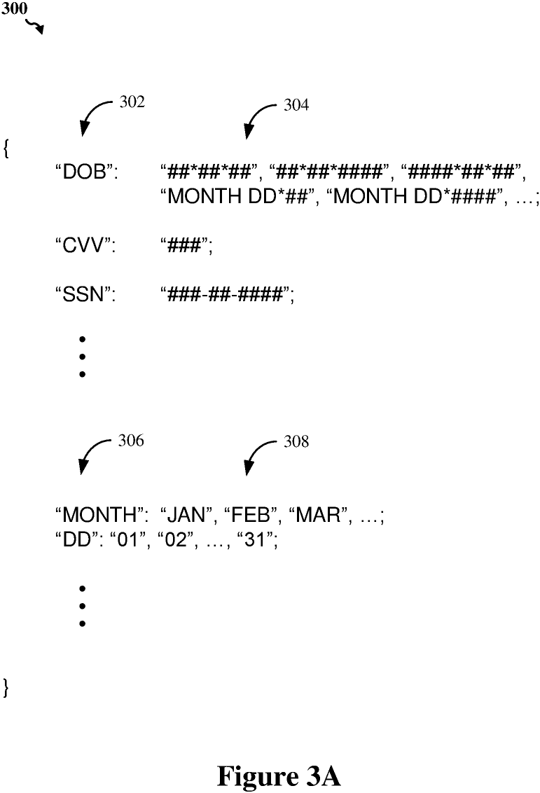

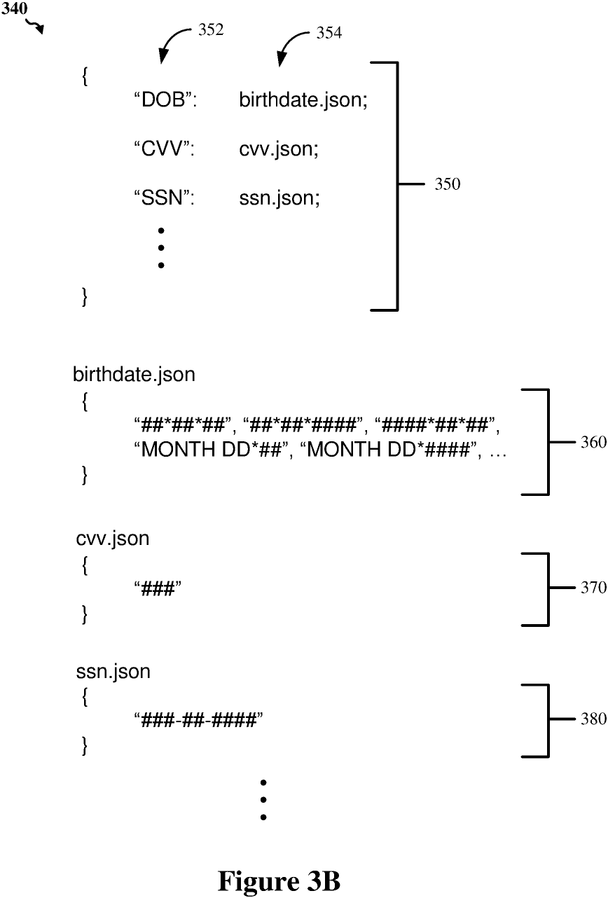

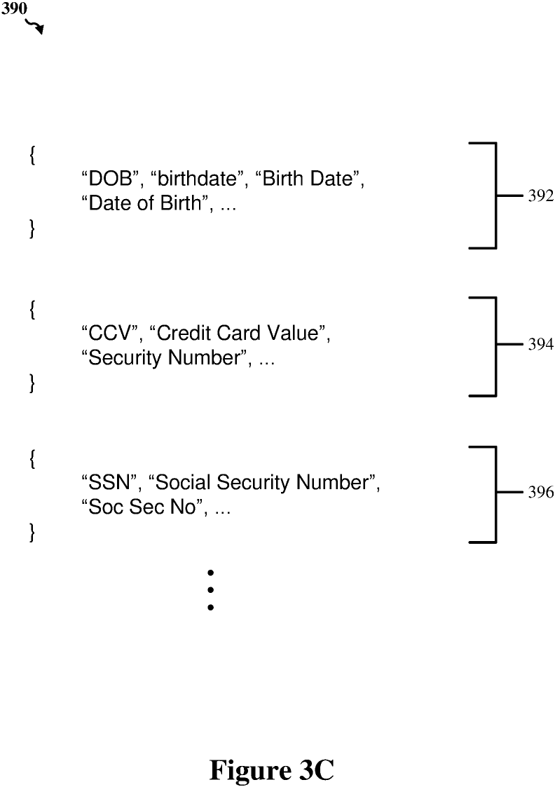

FIG. 3A shows an example dictionary 300, according to some implementations. The dictionary 300 includes a plurality of keys 302 and one or more expressions 304 associated with each key 302. For the computer readable logs generated while providing a service, the types of PII that may be included in a computer readable log are known, and the keys associated with the known types of PII are also known. For example, the software executed in providing the service may be configured to use specific keys associated with specific types of PII obtained during execution to generate one or more computer readable logs. As such, a programmer or team of programmers of a security team may manually generate a dictionary to include one or more known keys of a predefined format that are associated with one or more known types of PII that may be included in computer readable logs. The keys 302 are the same across all computer readable logs and are in the format as defined in the dictionary 300.

One or more expressions 304 corresponding to the one or more keys 302 are also included in the dictionary 300. As shown, multiple expressions or a single expression may be associated with the same key. While the example dictionary 300 depicts one expression 304 associated with one key 302, an expression may be associated with a plurality of keys. For example, if the computer readable logs are to include the keys “birthdate” and “DOB” to indicate date of birth, an expression may be associated with both keys in a dictionary. For the expressions 304, there may exist some variation in the characters of an expression. For example, a birthdate may include different numeric characters from 0 to 9. Special characters indicate characters that may vary for the expression. For example, ‘#’ indicates a numeric character from 0-9, and ‘*’ indicates a wildcard character (which may be, e.g., ‘/’, ‘-’, etc.). In some implementations, an expression may include a variable, such as “MONTH” or “DD”, that represents one of a set of character sequences. A variable 306 may be defined as a set of character sequences 308 in the same dictionary, as depicted in dictionary 300, or in a different dictionary or look-up table.

As shown in the dictionary 300, each key 302 has no variation in how it occurs in a log, while an expression 304 may have variation in how it occurs (such as different numbers existing in an expression as compared to a key). As such, a string search may be better than a regex search to search for a key in a computer readable log (since the sequence to be searched is static), and a regex search may be better than a string search to search for an expression in a computer readable log (since the sequence to be searched may be dynamic with varying characters). Referring back to FIG. 2, the system 200 may include a string search engine 240 and a regex search engine 260 to perform one or more string search algorithm based operations and one or more regular expression algorithm based operations, respectively.

As an alternative to the dictionary 300 in FIG. 3A, FIG. 3B shows an example plurality of dictionaries 340, according to some implementations. The plurality of dictionaries 340 include dictionaries 350, 360, 370, 380, and so on. As compared to dictionary 300 including pairs of keys and regular expressions, each PII type is associated with a separate dictionary of regular expressions. For example, the dictionary 350 includes one or more keys 352 to be searched for during a string search. One or more of the keys 352 are linked to other dictionaries 360, 370, 380, and so on (such as shown in the links 354) for different PII types. For example, key “DOB” is associated with dictionary “birthdate.json” 360 including one or more regular expressions for a birthdate PII type, key “CVV” is associated with dictionary “cvv.json” 370 including one or more regular expressions for a CVV PII type, and key “SSN” is associated with dictionary “ssn.json” 380 for an SSN PII type. In this manner, each PII type may be associated with a unique one or more dictionaries as compared to other PII types. While the dictionaries are depicted as json objects, the dictionaries may be any suitable object.

As an alternative to the dictionary 300 in FIG. 3A and plurality of dictionaries 340 in FIG. 3B, FIG. 3C shows an example plurality of dictionaries 390, according to some implementations. The plurality of dictionaries 390 include dictionaries 392, 394, 396, and so on. As depicted, each PII type is associated with a separate dictionary of keys. For example, the dictionary 392 includes one or more keys associated with a birthdate, the dictionary 394 includes one or more keys associated with a CVV, and the dictionary 396 includes one or more keys associated with an SSN. In some implementations, each dictionary for a different PII type may include a grouping of words to be used for string search of the particular PII type. While the dictionaries are depicted as json objects, the dictionaries may be any suitable object. For the example dictionaries 390, while not depicted, expressions to be used for a regex search may be included as a separate set of expressions. The set may be comprehensive for all PII types or may be in separate sets or subsets for different PII types. For example, each dictionary of keys for a unique PII type may be associated with a set of expressions for the unique PII type. In this manner, the associated set of expressions may be used for regex search for a key identified of a corresponding PII type. The one or more sets may be included in separate files or objects or may be hardcoded into the software to perform the PII identification. As used herein, expressions being included in a dictionary may also refer to the expressions being in the one or more sets for a regex search. As such, keys and expressions being included in one or more dictionaries refers to any suitable manner in defining keys to be searched for using a string search and expressions to be searched for using a regex search.

While the example dictionaries depict each PII type including keys and corresponding expressions, in some implementations, some PII types may include only keys. For example, a US state may be listed specifically in two letter formats in the one or more computer readable logs. As such, the two letter format may be searched for as a key in the one or more computer readable logs. In this manner, no expression is to be searched for for the identified state. Instead, the identified key may be considered PII.

The string search engine 240 identifies one or more instances of one or more keys in computer readable logs. For example, the string search engine 240 may use one or more dictionaries to configure its search for a key, and the string search engine 240 may search for the key across the entire string of characters of one or more computer readable logs. Any suitable string search algorithm may be performed by the string search engine 240, such as the Aho-Corasick algorithm, the Boyer-Moore algorithm, the Rabin-Karp algorithm, the Knuth-Morris-Pratt algorithm, or the Z algorithm.

The regex search engine 260 identifies one or more expressions associated with the one or more keys in one or more computer readable logs, with the expressions identified being the detected PII. In some implementations, when a key is identified, the regex search engine 240 may use one or more dictionaries to search for an expression associated with the identified key. For example, if the string search engine 240 identifies “DOB” in a computer readable log, the regex search engine 260 may search for a corresponding expression indicative of a date of birth. Any suitable implementation of a regex search algorithm may be performed by the regex search engine 260.

The keys defined in the one or more dictionaries are to be inclusive of all PII that are to be searched for in the computer readable logs. As such, a string search may be performed to attempt to identify any instances of the keys defined in the one or more dictionaries. If no instances of any key is identified, the system 200 may determine that no PII exists in the computer readable log or may otherwise prevent a regex search from being performed on the computer readable log. The system 200 may reduce the number of computer readable logs on which to perform a regex search from all of the computer readable logs to logs with at least one instance of a key identified using the string search, and the system 200 may perform the regex search for any expressions corresponding to the identified keys in order to identify PII in the remaining computer readable logs. Since the string search may be much faster and less computationally complex than a regex search, performing a string search in combination with a regex search to identify PII may be faster and less computationally complex than exclusively performing a regex search to identify PII across all logs.

In addition or alternative to reducing the number of computer readable logs on which to perform a regex search, a string search may be used to reduce the portions of a computer readable log on which to perform a regex search. As shown in the examples (1) and (2) above, a key is within a few characters (or otherwise within close proximity) in the string of characters of the computer readable log of its corresponding expression. For example, for example (2), the key “DOB” is two characters removed from the corresponding expression “1980/01/01”. Since the key is in close proximity to the corresponding expression, the system 200 may be configured to use a string search by the string search engine 240 to limit the range of characters in a computer readable log in which to perform a regex search for an expression. For example, if a key is found in a computer readable log using a string search, the system 200 may be configured to perform a regex search to look for one or more associated expressions within a window of characters neighboring or surrounding the identified key. In this manner, a regex search may not be performed on the entirety of a computer readable log. Since the string search engine 240 looks for predefined and static strings of characters, the string search engine 240 may perform a string search across the entirety of a computer readable log much faster than a regex search may be performed across the entirety of the computer readable log. As such, using a string search to limit the areas to which a regex search is to be performed reduces the processing resources and time required to identify PII in computer readable logs. In addition, since a regex search is still being performed on relative portions of the computer readable logs, accuracy is identifying PII is maintained as compared to using a regex search across the entirety of computer readable logs.

While the string search engine 240 and the regex search engine 260 are depicted as separate, single components of the system 200 in FIG. 2, the string search engine 240 and/or the regex search engine 260 may include additional components, may include software including instructions stored in memory 235 or the database 220, may include application specific hardware (e.g., one or more ASICs), or a combination of the above. As such, the particular architecture of the system 200 shown in FIG. 2 is but one example of a variety of different architectures within which aspects of the present disclosure may be implemented. While the examples herein are described with reference to system 200, any suitable system may be used to perform the operations described herein. In addition, while dictionaries 300, 340, and 390 are depicted as example dictionaries to be used to perform string search operations and regex search operations, any suitable dictionary or plurality of dictionaries may be used by the system to perform the operations described herein. For example, dictionary 300 may be split up into a plurality of dictionaries, with each dictionary being associated with a different PII type as compared to the other dictionaries.

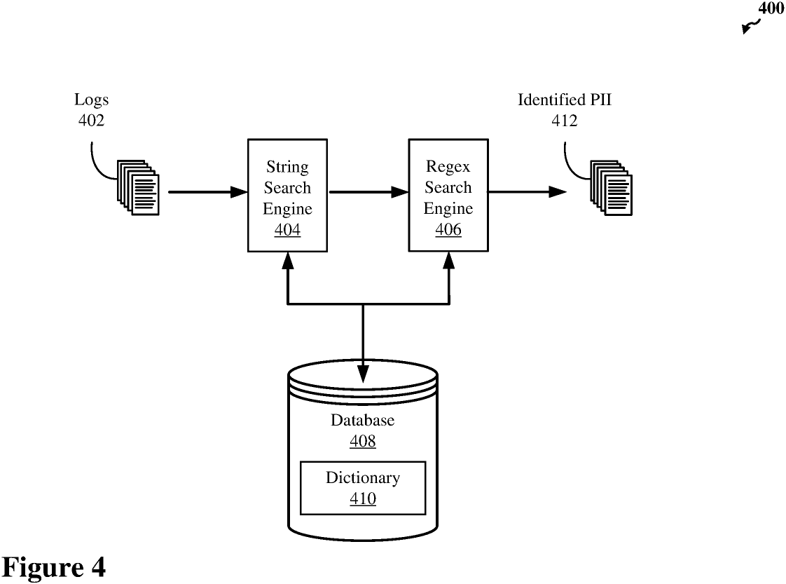

FIG. 4 shows an example process flow 400 to detect PII, according to some implementations. In some implementations, performing a string search and a regex search on a computer readable log is a sequential process. For example, for one or more computer readable logs to be reviewed for PII (with each computer readable log including a string of characters, such as the string of characters in example (1) or example (2) above), a string search is used to restrict the range of character strings for which a regex search is performed. As depicted, one or more computer readable logs 402 may be provided to the string search engine 404 to perform one or more string search algorithm based operations. The logs 402 may be received using a system interface (such as interface 210) to another device, or the logs 402 may be stored in and accessed from a local database or another suitable local memory.

The string search engine 404 may be an implementation of the string search engine 240 in system 200. For example, a processor executing instructions to perform the functions of the string search engine 404 may access the database 408 (which may be an implementation of the database 220 in system 200) to obtain the keys from the dictionary 410 to be searched for in the one or more computer readable logs 402. The string search engine 404 is configured to search for the one or more keys as defined in the dictionary 410 in a computer readable log (such as being configured to perform the string search for each key to be searched for) to attempt to identify any keys in the computer readable log. If no keys are identified in a computer readable log, the computer readable log may be identified as not including PII or may otherwise be prevented from use in performing a regex search. As such, the computer readable log may not be provided to the regex search engine 406 or may be provided without any identification of keys in the computer readable log.

If any key is identified in the computer readable log, the computer readable log may be passed to the regex search engine 406 to perform one or more regex search algorithm based operations. The regex search engine 406 may be an example implementation of the regex search engine 260 in system 200. For example, a processor may execute instructions to perform the functions of the regex search engine 406 to access the database 408 to obtain an expression corresponding to an identified key from the dictionary 410 to be searched for in the one or more computer readable logs 402. In some implementations, the log after performing the string search may be stored in a local memory for the regex search engine 406 to access to perform a regex search. The regex search engine 406 is configured to search for the expression defined in the dictionary 410 in the computer readable log. In some implementations, the regex search engine 406 searches for the expression in a window of characters neighboring the identified key (which may include surrounding the identified key) in the computer readable log. If the regex search engine 406 identifies any expressions in the computer readable log, the regex search engine may output an indication of the identified PII 412 in the computer readable log.

To note, processing of a plurality of logs 402 may be performed in any suitable manner. In some implementations, the string search engine 404 may be configured to process a plurality of logs 402 concurrently. In some other implementations, the string search engine 404 may be configured to process logs 402 sequentially. The regex search engine 406 may wait for the string search engine 404 to complete processing of a plurality of logs 402. For example, the string search engine 404 may store processed logs in the database 408, and the regex search engine 406 may access the stored processed logs to perform a regex search. In another example, the regex search engine 406 may process a log received from or stored by the string search engine 404 while the string search engine 404 processes a next log. As such, performing a string search and a regex search in a sequential manner on a plurality of computer readable logs may be performed in any suitable manner.

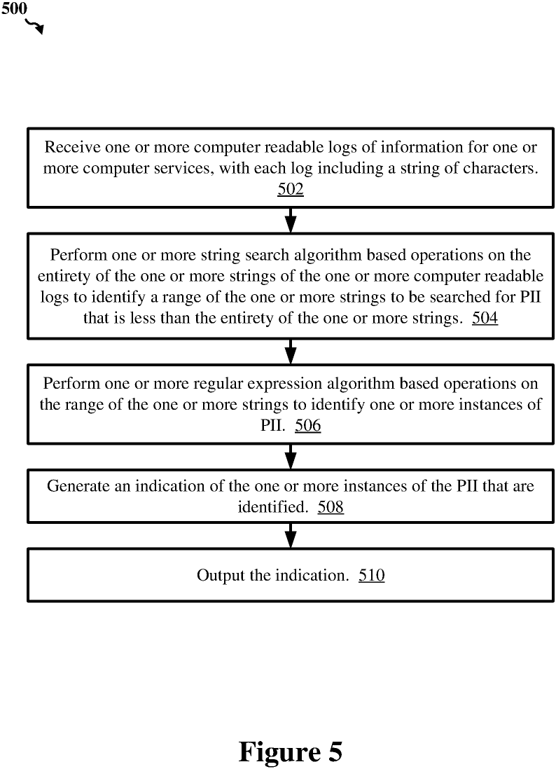

FIG. 5 shows an illustrative flow chart depicting an example process 500 for detecting PII in one or more computer readable logs, according to some implementations. The example operation 500 is described as being performed by the system 200 for clarity, but any suitable system may be used to perform the example operation 500. At 502, the system 200 receives one or more computer readable logs of information for one or more computer services, with each log including a string of characters. In some implementations, the interface 210 receives the one or more logs from other devices communicably coupled to the system 200 (such as from other devices hosting the one or more computer services). The received logs may be stored in the database 220, the memory 235, or another suitable memory of the system 200 for processing. In some other implementations, the system 200 may generate the one or more logs while hosting a computer service, and the system 200 stores the one or more logs in the database 220, the memory 235, or another suitable memory of the system 200. In this manner, receiving the one or more logs may refer to receiving the logs from another device via the interface 210 or receiving the logs from the database 220, the memory 235, or another suitable memory of the system 200. The one or more logs may be for one service or for a plurality of services as long as one or more dictionaries to be used define the keys to be searched for in the one or more logs.

As noted above, each computer readable log includes a string of characters. For example, each of example (1) and example (2) depicted above includes a string of characters that begins at opening bracket ‘{’ and ends at closing bracket ‘}’. The string of characters for each of the one or more logs is to be searched for PII.

At 504, the system 200 (such as the string search engine 240) performs one or more string search algorithm based operations on the entirety of the one or more strings of the one or more computer readable logs to identify a range of the one or more strings to be searched for PII that is less than the entirety of the one or more strings. In some implementations, performing the one or more string search algorithm based operations includes using one or more dictionaries to identify one or more instances of one or more keys in the one or more strings. For example, if the entirety of ten logs are to be searched using the dictionary 300 in FIG. 3A, the dictionary 350 in FIG. 3B, or the dictionary 390 in FIG. 3C, the system 200 may perform a string search on the entire string of the first log, the second log, through the tenth log to search for any instances of “DOB”, “CVV”, “SSN”, and so on of the keys defined in the dictionaries. To note, the one or more dictionaries to be used define a plurality of keys of a sequence of characters (such as “DOB”, “CVV”, and so on), and each key of the plurality of keys is associated with PII.

Performing the one or more string search algorithm based operations to identify a range to be searched for PII that is less than the entirety of the one or more strings may include identifying which logs include at least one instance of a key. In this manner, any logs without an instance of any key may be excluded from being searched using a regex search. If the ten logs in the above example are searched for instances of keys defined by the one or more dictionaries, and only the ninth log includes any instance of any key, the other nine logs may be excluded from being searched using a regex search or otherwise indicated as not including PII. Additional or alternative to identifying which logs include an instance of a key, performing the one or more string search algorithm based operations includes, for each instance of an identified key in the one or more strings, identifying a window of characters in the one or more strings neighboring the instance of the identified key (with the window to be searched for PII). For example, portions of the ninth log outside of a window associated with the identified instance of the key may be excluded from being searched using a regex search. In this manner, a regex search may be restricted to a subset of logs and subsets (windows) of characters for each of the subset of logs.

To note, more than one instance of the same key or different keys may be identified in the same log. For example, using the above example (2) and the following keys “Phone”, “Address”, and “DOB” defined in one or more dictionaries, the system 200 may identify the keys, such as shown in underline in example (3) below:

{“Id”:“1234”,“Line1”:“Address:567”,“Line2”:“Carowinds Street”,“Line3”:“Phone: (3)
438-490-3638”,“Line4”:“Email:example@email.com”,“Line5”:“DOB:1980/01/01”}

For each instance, the system 200 may identify a window of characters neighboring the instance, such as shown in double brackets (“[[ ]]”) in example (4) below:

{“Id”:“1234”,“Line1”:“Address[[:567”,“Line2”:“Carowinds Street”,“L]]ine3”:“Phone (4)
[[:438-490-3638”,]]“Line4”:“Email:example@email.com”,“Line5”:“DOB[[:1980/01/01”]]}

Each window of characters is to be searched for PII. For example, the string portion “:567”,“Line2”:“Carowinds Street”,“L” in the window neighboring the key “Address” may be searched for an address, the string portion “:438-490-3638″,” in the window neighboring the key “Phone” may be searched for a phone number, and the string portion “:1980/01/01″” in the window neighboring the key “DOB” may be searched for a birthdate. As described below with reference to block 506 of process 500, the remainder of the log outside of the windows may not be used during a regex search to identify an address, a phone number, or a birthdate.

To note, the windows may be any suitable length and any suitable location. For example, while a window is depicted in the examples as succeeding a key for clarity, a window may precede the key, or the window may surround the key such that characters before and after the key are to be searched. In some implementations, each window may be the same length of characters. In some other implementations, a window length may vary based on, e.g., the type of key identified. For example, a window length associated with the key “DOB” may be shorter than a window length associated with the key “Address”. While not depicted in dictionaries 300, 340, or 390, in some implementations, the length of the window to be used may be indicated in a dictionary for one or more keys. The dictionary may also indicate where the window is to be located with reference to the identified key (such as before or after the key). If the window length or position is not indicated in the dictionary for an identified key, the system 200 may use a default window length (such as twenty characters) or a default window position (such as immediately after the key) in identifying a window for the identified key.

As noted above, any suitable string search algorithm may be used to identify the range. In some implementations, the string search algorithm includes the Aho-Corasick algorithm to search for one or more keys. In using a string search to reduce the number of logs on which to perform a regex search and/or to reduce the area of a log on which to perform the regex search, the system 200 identifies a range of the one or more strings to be search for PII that is less than the entirety of the one or more strings.

At 506, the system 200 performs one or more regular expression algorithm based operations on the range of the one or more strings to identify one or more instances of PII. In some implementations, performing the one or more regular expression algorithm based operations includes preventing performing the one or more regular expression algorithm based operations on logs not including an identified key. Additionally or alternatively, performing the one or more regular expression algorithm based operations may include preventing performing the one or more regular expression algorithm based operations on the portions of the one or more logs outside of the one or more windows. In other words, any logs outside the identified range or any portions of a log outside the windows of the identified range are not used by the system 200 in performing a regex search. As noted above and depicted in example (4), the identified range may include one or more windows of one or more logs. In this manner, performing the one or more regular expression algorithm based operations on the range may include performing the one or more regular expression algorithm based operations on the one or more windows. In other words, a regex search may be restricted to the windows identified during the string search.

As noted above, each window is associated with a specific key identified in the log. In searching the one or more windows, the system 200 may search for one or more instances of one or more expressions associated with a key within each window associated with the key. For example, referring back to example (4), the system 200 may search for a birthdate in the string portion “:1980/01/01″” in the window neighboring the key “DOB”. Each expression to be searched for is associated with a potential format of PII for the associated key. As noted above, the potential formats of the expressions may be indicated in the one or more dictionaries. In this manner, the one or more expressions for a key are defined in the one or more dictionaries, and the system 200 uses the one or more dictionaries to identify the one or more instances of the one or more expressions. To note, expressions may be defined for any number of keys, while some keys may not be associated with expressions (such as keys that are already considered PII, such as described above).

For example, if the dictionary 300 or the dictionary 360 is used to search for a birthdate expression in the string portion “:1980/01/01″” in the window neighboring the key “DOB” in example (4), the system 200 may use a regex search to search for a birthdate expressed in the formats: (i) “##*##*##”; (ii) “##*##*####”; (iii) “####*##*##”; and so on. While using expression formats (i) and (ii) to perform a regex search on the window does not yield any results, using expression format (iii) to perform the regex search yields the result “1980/01/01”. To note, performing a regex search using a plurality of potential expression formats of PII may be performed recursively for the different formats or may be performed concurrently for the different formats. For example, the regex search engine 260 may attempt to identify a first formatted PII in a window. If the search fails, the regex search engine 260 may be configured to identify a second formatted PII in the window and search the window. The process may repeat until all formats of PII are searched for the window or until a match is found. In another example, the regex search engine may allow parallel processing of different instances of a window to allow searching for different formats of PII at the same time. The regex search may be performed in any suitable manner, and the present disclosure is not limited to the provided examples. To note, performing a regex search for one or more expressions defined in a dictionary may also refer to searching for expressions in a set of expressions outside of dictionaries of keys for different PII types.

In performing the one or more regular expression algorithm based operations on the identified range, the system 200 may restrict expressions searched for in a portion of the range to one or more expressions defined as corresponding to a key associated with the portion of the range. In some implementations, the system 200 may prevent performing a regex search to search a log for an expression not associated with a key identified in the log. For example, referring back to example (4) and using dictionary 300 or dictionary 340, since the key “CVV” is not identified in the log, the expression “###” associated with the key “CVV” is not searched for in the log. In addition or alternative to limiting searching of expressions in a log to expressions associated with a key identified in the log, the system 200 may limit searching of expressions in a window to expressions associated with the identified key corresponding to the window. For example, referring back to example (4), the character string “:567”,“Line2”:“Carowinds Street”,“L” in the window corresponding to the key “Address” is to be searched only for an expression associated with the key “Address”. Using the dictionary 300 or dictionary 340, the system 200 prevents searching for the expressions associated with the keys “DOB”, “CVV”, and “SSN” in the window since the expressions are not associated with the key “Address”.

In reducing the range of logs to be searched for expressions of PII by identifying windows of character strings associated with identified keys and limiting the number of expressions to be searched for in a window based on the identified key associated with the window, the time and processing resources required to perform the regex search operations is significantly reduced as compared to performing a regex search for all expressions across the entirety of one or more logs.

If the string search engine 240 performs the string search to identify one or more keys and the regex search engine 260 performs the regex search to identify one or more expressions as PII in one or more logs, the string search engine 240 is to indicate to the regex search engine 260 the instances of keys identified or information regarding the location of the key instances in the one or more logs. In some implementations, if the original logs are stored in the database 220, the system 200 may generate a copy of a log in order to perform a string search and regex search. When a string search is performed on the log (which may be the copy), the string search engine 240 may include a header or other legend of information in the log to indicate the keys identified and the corresponding windows identified. For example, the header may include a list of keys identified and the position and length of the window for each key. The position and length of the window may be in number of characters for the log, such as characters 28 - 62 of the log in example (4) for key “Address”, or the position of the window may be based on a position of the key, which may be indicated in the header. In addition or alternative to a header or other legend, the system 200 may use special characters in the log to indicate the keys identified and the locations of the corresponding windows to be searched for PII. In some implementations, the header or legend of the log may be updated by the regex search engine 260 to indicate the PII detected in the log (which are the expressions identified in the log by the regex search engine 260). For example, a header may include a location and type of PII detected in the log. In another example, special characters in the log may be used to identify the location and type of PII detected.

In addition or alternative to modifying the log to indicate the keys or windows to be searched, the system 200 may use a separate index to indicate the keys identified and/or the corresponding windows identified. For example, referring back to example (4), the log includes an ID of 1234 that may be used to identify the log. The index may include entries for each of the logs based on the ID, and for each ID, the index may include information regarding the keys identified and the corresponding windows identified for that log. The string search engine 240 may update the index to include the information regarding keys and windows to be used by the regex search engine 260. In this manner, the regex search engine 260 may use the index and the one or more dictionaries to determine the character string in a window of a log to be searched and the expressions to be searched for in the window. In some implementations, the index may be updated by the regex search engine 260 to include any PII detected by the regex search engine 260. For example, with reference to example (4), the index may include an entry for log ID 1234 and key “DOB” that the expression/PII detected in the window is “1980/01/01” found at characters 136-145 of the log. In this manner, the index may be used as a summary of PII detected across one or more logs searched by the system 200.

Referring to the one or more dictionaries to be used in performing the string search and the regex search, the one or more dictionaries are to define the keys and the corresponding expressions. For example, dictionary 300 or dictionaries 350 and 380 define a key “SSN” and an associated expression “###-##-####”. In order for a dictionary to be used for the string search and the regex search, the dictionary is to exist before such operations are performed. The system 200 may obtain the one or more dictionaries to be used before performing the one or more string search algorithm based operations (and the one or more regular expression search algorithm based operations). For example, a security team may use the system 200 to manually generate a dictionary, or a previously generated dictionary may be transmitted to the system 200 for use. Since the formats of the keys and the formats of the associated expressions are known for a service being provided, the dictionary may be generated to include all PII of interest in the computer readable logs generated for the computer service.

Various services may be updated over time. For example, as hardware and software evolve over time, a service may be updated to stay current. A service may also be updated to include new features or otherwise improve functionality. As a result, the PII in logs may change over time. For example, the format of an expression may change or new types of PII may exist in newer computer readable logs. In some implementations, the system 200 may periodically update the one or more dictionaries based on one or more of a string search performed or a regex search performed. For example, all logs generated may be assumed to have at least one instance of PII. If a string search is performed on a log and no key is identified, the log may be flagged to a security team for review. The security team may identify a new key or a change in format to an existing key and update the one or more dictionaries used to perform the string search at the system 200 to include the updated key (and a corresponding expression). In another example, if the system 200 performs a regex search in a log or a window of the log corresponding to an identified key but no expression is identified in the log or in the window of the log, the log or window may be flagged to the security team for review. The security team may review the flagged portion to identify a new expression or updated expression format for the identified key, and the one or more dictionaries at the system 200 may be updated to include the new or updated expression. To note, updating the expressions in the one or more dictionaries may refer to updating the set of expressions to be used. In this manner, the one or more dictionaries used may remain up to date for detection of any PII of interest in the logs.

While the above examples depict all types of PII as being of equal sensitivity, in some implementations, different types of PII may be associated with different levels of sensitivity. For example, a user’s account password may be more sensitive than the user’s full name, and the password is to be hidden from everyone except a dedicated security team while the name may be seen by some company employees other than the security team. In another example, a user’s SSN may be more sensitive than the user’s email address, and the SSN is to be hidden from everyone except a dedicated security team while the email address may be seen by some company employees other than the security team. Increasing the level of sensitivity of PII may reduce who is allowed to access such PII. For example, a first sensitivity level may restrict PII to being seen by employees of the company providing the service. A second sensitivity level may restrict PII to being seen by a subset of the employees (such as executives and those with security clearance). A third sensitivity level may restrict PII to being seen by an even smaller subset of employees (such as only a security team entrusted to protect PII stored at the company). To note, any suitable number of sensitivity levels may exist.

In some implementations, the system 200 may be configured to search for PII at varying levels of sensitivity. For example, different dictionaries may include keys of PII at different levels of sensitivity. A first dictionary may include keys and associated expressions for a first sensitivity level of PII, a second dictionary may include keys and associated expression for a second sensitivity level of PII (which may or may not include the keys and expression for the first sensitivity level of PII), and so on. A system 200 may receive an indication as to the sensitivity level to be used, and the system 200 may select the dictionaries to be used for the searches based on the indication. Alternatively, a single dictionary may be configured to differentiate between different sensitivity levels for PII. For example, each key may include an identifier to indicate the sensitivity level associated with the key. The system 200 may receive an indication as to the sensitivity level to be used, and the system 200 may determine the keys to be searched for based on the keys’ identifiers and the indication as to the sensitivity level to be used. In this manner, the system 200 may be able to adjust what PII is to be searched for in the computer readable logs based on the level of sensitivity for the PII. If the system 200 may periodically update the one or more dictionaries, the system 200 may update the sensitivity levels for one or more PII (such as based on a received indication to change a sensitivity level of a specific PII).

Referring back to FIG. 5, at 508, the system 200 generates an indication of the one or more instances of the PII that are identified. In some implementations, if the system 200 stores an index for the reviewed logs to indicate the keys or windows identified during a string search, the system 200 may update the index to indicate the expressions identified during a regex search. In some other implementations, if the system 200 is to modify a computer readable log to indicate a window identified, the system 200 may modify the log to indicate the expression identified in the window.

At 510, the system 200 (such as the interface 210) outputs the indication. For example, the system 200 may output the generated index or may output the modified logs. In some implementations, the system 200 may display the index and/or logs including PII to a local reviewer of a security team to review the information. In some other implementations, the system 200 may transmit the index and/or logs including PII over a secure connection to another device for review by a reviewer of the security team. The reviewer may review such information to perform one or more actions to obfuscate the PII or to otherwise prevent others from accessing the PII. For example, the logs including PII may be quarantined or otherwise restricted from access by others. In another example, a log may be scrubbed such that the PII in the log is removed or replaced. If the scrubbed logs are copies, the original logs may still reside in the original repository or the system 200 for use in performing the service while the scrubbed copies with obfuscated PII may be accessed by others. If varying sensitivity levels of PII may be detected, various instances of a scrubbed log may exist. In this manner, a first scrubbed copy may have a first sensitivity level PII removed while a second scrubbed copy may have a second sensitivity level PII removed.

While not depicted in operation 500 of FIG. 5, in some implementations, the system 200 may automatically scrub logs including detected PII. For example, the system 200 may automatically generate copies of logs, scrub the copies, and output the scrubbed copies. In this manner, if a person wishes to review the logs for information other than PII (such as performing various statistical analysis regarding the service being provided), the system 200 is capable of providing the scrubbed copies or otherwise hiding PII so that the person to be able to access the logs for review. To note, automatic scrubbing may also be based on the sensitivity level of PII to be detected. In some implementations, the scrubbed copies may be provided to a repository for storage and access by others. As such, a company is able to protect PII while still allowing access by others to non-PII portions of computer readable logs.

As described herein, a system to automatically perform string searching prior to regex searching to detect and secure PII in computer readable logs for a service allows the system to review a multitude of logs, which may be performed in near real time or in a manner that is able to protect such PII before the logs are to be accessed. Since a string search limits the portions of the logs in which a regex search is to be performed, and the string search limits the expressions to be searched in those portions, the detection of PII may be performed on a large corpus of logs in a realistic time frame using current computing systems and resources.

While example implementations are described above for clarity in disclosing aspects of the present disclosure, various modifications to the implementations described in this disclosure may be readily apparent to those skilled in the art, and the principles defined herein may be applied to other implementations without departing from the spirit or scope of this disclosure.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

If implemented in software, the functions may be stored on or transmitted over as one or more instructions or code on a computer readable medium. The processes of a method or algorithm disclosed herein may be implemented in a processor-executable software module which may reside on a computer readable medium. Computer readable media includes both computer storage media and communication media including any medium that can be enabled to transfer a computer program from one place to another. A storage media may be any available media that may be accessed by a computer. By way of example, and not limitation, such computer readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer readable media. Additionally, the operations of a method or algorithm may reside as one or any combination or set of codes and instructions on a machine readable medium and computer readable medium, which may be incorporated into a computer program product.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c, and “one or more of: a, b, or c” is intended to cover: a, b, c, a-b, a-c, b-c, and a-b-c. In addition, while the figures and description depict an order of operations to be performed in performing aspects of the present disclosure, one or more operations may be performed in any order or concurrently to perform the described aspects of the disclosure. In addition, or to the alternative, a depicted operation may be split into multiple operations, or multiple operations that are depicted may be combined into a single operation.

The claims presented herein are not intended to be limited to the implementations shown herein but are to be accorded the widest scope consistent with this disclosure, the principles, and the novel features disclosed herein.

What is claimed is:

1. A computer-implemented method for automatic detection of personal identifiable information (PII), comprising:
receiving one or more computer readable logs of information for one or more computer services, wherein each log includes a string of characters;
performing one or more string search algorithm based operations on the entirety of the one or more strings of the one or more computer readable logs to identify a range of the one or more strings to be searched for PII that is less than the entirety of the one or more strings;
performing one or more regular expression algorithm based operations on the range of the one or more strings to identify one or more instances of PII;
generating an indication of the one or more instances of the PII that are identified; and
outputting the indication.

2. The computer-implemented method of claim 1, wherein performing the one or more regular expression algorithm based operations includes restricting expressions searched for in a portion of the range to one or more expressions defined as corresponding to a key associated with the portion of the range.

3. The computer-implemented method of claim 1, wherein performing the one or more string search algorithm based operations includes using one or more dictionaries to identify one or more instances of one or more keys in the one or more strings, wherein:
the one or more dictionaries define a plurality of keys of a sequence of characters; and
each key of the plurality of keys is associated with PII.

4. The computer-implemented method of claim 3, wherein the string search algorithm includes the Aho-Corasick algorithm.

5. The computer-implemented method of claim 3, wherein performing the one or more string search algorithm based operations includes, for each instance of an identified key in the one or more strings, identifying a window of characters in the one or more strings neighboring the instance of the identified key, wherein the window is to be searched for PII.

6. The method of claim 5, further comprising preventing performing the one or more regular expression algorithm based operations on the portions of the one or more logs outside of the one or more windows, wherein performing the one or more regular expression algorithm based operations on the range includes performing the one or more regular expression algorithm based operations on the one or more windows.

7. The computer-implemented method of claim 6, wherein performing the one or more regular expression algorithm based operations on the one or more windows includes searching for one or more instances of one or more expressions associated with a key within each window associated with the key, wherein each expression of the one or more expressions is associated with a potential format of PII for the associated key.

8. The computer-implemented method of claim 7, wherein:
the one or more expressions for the key are defined in the one or more dictionaries; and
performing the one or more regular expression algorithm based operations on the one or more windows includes using the one or more dictionaries to identify the one or more instances of one or more expressions.

9. The computer-implemented method of claim 5, wherein one or more of a length or a location of a window for an instance of an identified key may vary based on the key.

10. The computer-implemented method of claim 1, further comprising:
scrubbing at least one computer readable log of the one or more computer readable logs to obfuscate identified PII in the at least one computer readable log.

11. A system for automatic detection of personal identifiable information (PII), the system comprising:
one or more processors; and
a memory storing instructions that, when executed by the one or more processors, causes the system to perform operations comprising:
receiving one or more computer readable logs of information for one or more computer services, wherein each log includes a string of characters;
performing one or more string search algorithm based operations on the entirety of the one or more strings of the one or more computer readable logs to identify a range of the one or more strings to be searched for PII that is less than the entirety of the one or more strings;
performing one or more regular expression algorithm based operations on the range of the one or more strings to identify one or more instances of PII;
generating an indication of the one or more instances of the PII that are identified; and
outputting the indication.

12. The system of claim 11, wherein performing the one or more regular expression algorithm based operations includes restricting expressions searched for in a portion of the range to one or more expressions defined as corresponding to a key associated with the portion of the range.

13. The system of claim 11, wherein performing the one or more string search algorithm based operations includes using one or more dictionaries to identify one or more instances of one or more keys in the one or more strings, wherein:
the one or more dictionaries define a plurality of keys of a sequence of characters; and
each key of the plurality of keys is associated with PII.

14. The system of claim 13, wherein the string search algorithm includes the Aho-Corasick algorithm.

15. The system of claim 13, wherein performing the one or more string search algorithm based operations includes, for each instance of an identified key in the one or more strings, identifying a window of characters in the one or more strings neighboring the instance of the identified key, wherein the window is to be searched for PII.

16. The system of claim 15, wherein the operations further comprise preventing performing the one or more regular expression algorithm based operations on the portions of the one or more logs outside of the one or more windows, wherein performing the one or more regular expression algorithm based operations on the range includes performing the one or more regular expression algorithm based operations on the one or more windows.

17. The system of claim 16, wherein performing the one or more regular expression algorithm based operations on the one or more windows includes searching for one or more instances of one or more expressions associated with a key within each window associated with the key, wherein each expression of the one or more expressions is associated with a potential format of PII for the associated key.

18. The system of claim 17, wherein:
the one or more expressions for the key are defined in the one or more dictionaries; and
performing the one or more regular expression algorithm based operations on the one or more windows includes using the one or more dictionaries to identify the one or more instances of one or more expressions.

19. The system of claim 15, wherein one or more of a length or a location of a window for an instance of an identified key may vary based on the key.

20. The system of claim 11, wherein the operations further comprise:
scrubbing at least one computer readable log of the one or more computer readable logs to obfuscate identified PII in the at least one computer readable log.
